(19) United States
(12) Patent Application Publication
(10) Pub. No.: US 2023/0300894 A1
(43) Pub. Date: Sep. 21, 2023

(54) Method and Apparatus for Configuring Radio Resource in a Wireless Network

(71) Applicant: Telefonaktiebolaget LM Ericsson (publ), Stockholm (SE)

(72) Inventors: Liping Zhang, Beijing (CN); Ritesh Shreevastav, Upplands Väsby (SE); Jie Chen, Beijing (CN); Emre Yavuz, Stockholm (SE); Gerardo Agni Medina Acosta, Märsta (SE)

(21) Appl. No.: 18/021,448

(22) PCT Filed: Aug. 16, 2021
(86) PCT No.: PCT/SE2021/050794

§ 371 Date: Feb. 15, 2023

(30) Foreign Application Priority Data
Aug. 18, 2020 (WO) PCT/CN2020/109863

(51) Int. Cl. H04W 74/08; H04W 68/02

(52) U.S. Cl. CPC H04W 74/0833; H04W 68/02

(57) ABSTRACT

The present application generally relates to wireless communication technology. More particularly, the present application relates to a method and an apparatus for configuring radio resource for a terminal device in a 5 wireless network. The present application also relates to a method for utilizing radio resource in a wireless network and a terminal device adapted for the same purpose. The present application also relates to computer program product adapted for the same purpose. According to one aspect of the present disclosure, a method for configuring radio 10 resource for a terminal device in a wireless network comprises:—a) generating allocation information configured to allocate physical random access channel (PRACH) resources for non-anchor carriers to an enhanced coverage level, wherein a respective selection probability, on the basis of which the terminal device makes a PRACH resources 15 selection to carry out physical random access, is assigned to each of the PRACH resources for non-anchor carriers; and—b) sending the allocation information to the terminal device.

### TECHNICAL FIELD

The present disclosure generally relates to wireless communication technology. More particularly, the present disclosure relates to a method and an apparatus for configuring radio resource for a terminal device in a wireless network. The present disclosure also relates to a method for utilizing radio resource in a wireless network and a terminal device adapted for the same purpose. The present disclosure also relates to computer program product adapted for the same purpose.

### BACKGROUND

Narrowband Internet of Things (NB-IoT) is a Low Power Wide Area Network (LPWAN) radio technology standard developed by 3GPP to enable a wide range of cellular devices and services. NB-IoT focuses specifically on indoor coverage, low cost, long battery life, and high connection density. NB-IoT uses a subset of the LTE standard, but limits the bandwidth to a single narrow-band. It uses orthogonal frequency division multiplexing (OFDM) modulation for downlink communication and single-carrier frequency-division multiple access (SC-FDMA) for uplink communications. Applications which require more frequent communications will be better served by NB-IoT, which has no duty cycle limitations operating on the licensed spectrum.

For NB-IoT, radio environment impact on communication quality is characterized by coverage enhancement levels. Typically, three coverage enhancement (CE) levels, i.e., CE level 0 to CE level 2 are introduced. Among them, CE level 0 corresponds to normal coverage, and CE level 2 represents the worst case where the coverage is assumed to be very poor. The number of repetitions for transmitting a message may be determined on the basis of the CE levels.

Physical layer random access preambles are used by NB-IoT UEs camping on a given cell to notify a base station of its intention to get access. A preamble consists of four symbol groups transmitted next to each other using a different subcarrier per symbol group. Each symbol group has a Cyclic Prefix (CP) followed by 5 symbols, the CP has different duration depending on the preamble format. Narrow physical radio access channel (NPRACH) preamble repetition unit 5.6 ms or 6.4 ms depending on the CP.

The following knowledge for related Serving Cell is assumed to be available before a Random Access Procedure is initiated for NB-IoT UEs.
the available set of PRACH resources supported in the Serving Cell on anchor and non-anchor carriers.
for early data transmission (EDT), the available set of PRACH resources associated with EDT on anchor and non-anchor carriers.
for random access resource selection and preamble transmission:
   a PRACH resource is mapped into an enhanced coverage level.
   each PRACH resource contains a set of nprach-NumSubcarriers subcarriers.
wherein a subcarrier is identified by the subcarrier index in the following range:
[nprach-SubcarrierOffset, nprach-SubcarrierOffset+nprach-NumSubcarriers−1]

And each subcarrier of a Random Access Preamble group corresponds to a Random Access Preamble.
when the subcarrier index is explicitly sent from the eNB as part of a PDCCH order ra-PreambleIndex shall be set to the signaled subcarrier index.
the mapping between the PRACH resources and enhanced coverage levels is determined according to the following:
   the number of enhanced coverage levels is equal to one plus the number of RSRP thresholds present in rsrp-ThresholdsPrachInfoList.
   each enhanced coverage level has one anchor carrier PRACH resource present in nprach-ParametersList and zero or one PRACH resource for each non-anchor carrier signaled in ul-ConfigList.
   for EDT, each enhanced coverage level has zero or one anchor carrier PRACH resource present in nprach-ParametersList-EDT and zero or one PRACH resource for each non-anchor carrier signaled in ul-ConfigList.
   enhanced coverage levels are numbered from 0 and the mapping of PRACH resources to enhanced coverage levels are done in increasing numRepetitionsPerPreambleAttempt order.
   when multiple carriers provide PRACH resources for the same enhanced coverage level, a UE will randomly select one of them using the following selection probabilities:
      the selection probability of the anchor carrier PRACH resource for the given enhanced coverage level, nprach-ProbabilityAnchor, is given by the corresponding entry in nprach-ProbabilityAnchorList
      the selection probability is equal for all non-anchor carrier PRACH resources and the probability of selecting one PRACH resource on a given non-anchor carrier is determined as follows:
         (1-nprach-ProbabilityAnchor)/(number of non-anchor NPRACH resources)

In the existing solutions, however, the flexibility is very limited for NB-IoT carrier selection based on enhanced coverage levels for NPRACH resources.

For paging as specified in 3GPP TS 36.304, which is incorporated herein by reference in its entirety, the paging-related parameters and static parameter such as UE_ID are used for selecting a paging carrier. However, at a network side, it may assign different weights for different paging carriers to steer the paging load across the paging carriers.

If paging configuration for non-anchor carrier is provided in system information, then the paging carrier is determined by the paging carrier with smallest index n (0≤n≤Nn−1) fulfilling the following equation:

floor(UE_ID/(N*Ns))mod W<W(0)+W(1)+ . . . +W(n)

Where the parameters are identified as below:

T: DRX cycle of the UE. Except for NB-IoT, if a UE specific extended DRX value of 512 radio frames is configured by upper layers according to 7.3, T=512. Otherwise, T is determined by the shortest of the UE specific DRX value, if allocated by upper layers, and a default DRX value broadcast in system information. If UE specific DRX is not configured by upper layers, the default value is applied. UE specific DRX is not applicable for NB-IoT. In RRC_INACTIVE state, if extended DRX is not configured by upper layers as defined in 7.3, T is determined by the shortest of the RAN paging cycle, the UE specific paging cycle, and the default paging cycle, if allocated by upper layers. Otherwise, in RRC_INACTIVE state when extended DRX is configured by upper layers, T is determined by the shortest of the RAN paging cycle, the UE specific paging cycle, if allocated by upper layers and the default paging cycle during the PTW as defined in 7.3, and by the RAN paging cycle outside the PTW.

In the existing solutions, however, it provides a complicated mechanism to carry out paging carrier selection.

### SUMMARY

The present disclosure describes methods and apparatus for configuring radio resource for a terminal device in a wireless network, which allows a flexible and efficient PRACH resources selection.

According to one aspect of the present disclosure, a method for configuring radio resource for a terminal device in a wireless network comprises:
a) generating allocation information configured to allocate physical random access channel (PRACH) resources for non-anchor carriers to an enhanced coverage level, wherein a respective selection probability, on the basis of which the terminal device makes a PRACH resources selection to carry out physical random access, is assigned to each of the PRACH resources for non-anchor carriers; and
b) sending the allocation information to the terminal device.

According to another aspect of the present disclosure, an apparatus for configuring radio resource for a terminal device in a wireless network comprises:
a processor;
memory in communication with the processor; and instructions stored in the memory and operable, when executed by the processor, to cause the apparatus to:
a) generate allocation information configured to allocate physical random access channel (PRACH) resources for non-anchor carriers to an enhanced coverage level, wherein a respective selection probability, on the basis of which the terminal device makes a PRACH resources selection to carry out physical random access, is assigned to each of the PRACH resources for non-anchor carriers; and
b) send the allocation information to the terminal device.

According to another aspect of the present disclosure, a method for utilizing radio resource in a wireless network comprises:
a) receiving allocation information configured to allocate physical random access channel (PRACH) resources for non-anchor carriers to an enhanced coverage level, wherein a respective selection probability, on the basis of which a PRACH resources selection for non-anchor carriers is made to carry out physical random access, is assigned to each of the PRACH resources for non-anchor carriers; and
b) determining a current enhanced coverage level; and
c) for the current enhanced coverage level, selecting one or more resources from the PRACH resources for non-anchor carriers based on the allocation information so as to carry out the physical random access.

According to another aspect of the present disclosure, a terminal device comprises:
a processor;
memory in communication with the processor; and
instructions stored in the memory and operable, when executed by the processor, to cause the apparatus to:
a) receive allocation information configured to allocate physical random access channel (PRACH) resources for non-anchor carriers to an enhanced coverage level, wherein a respective selection probability, on the basis of which a PRACH resources selection for non-anchor carriers is made to carry out physical random access, is assigned to each of the PRACH resources for non-anchor carriers; and
b) determine a current enhanced coverage level; and
c) for the current enhanced coverage level, select one or more resources from the PRACH resources for non-anchor carriers based on the allocation information so as to carry out the physical random access.

According to another aspect of the present disclosure, a computer program product for, the computer program product being embodied in a computer readable storage medium and comprising computer instructions for performing anyone of the methods as described above.

### BRIEF DESCRIPTION OF THE DRAWINGS

The foregoing and other objects, features, and advantages would be apparent from the following more particular description of preferred embodiments as illustrated in the accompanying drawings in which:

FIG. 1 shows a typical Architecture for NB-IoT.

FIG. 2 schematically illustrates a flowchart of a method for configuring radio resource for a terminal device in a NB-IoT according to the present disclosure.

FIG. 3 is a block diagram illustrating an apparatus for configuring radio resource for a terminal device in a wireless network according to the present disclosure.

FIG. 4 schematically illustrates a flowchart of a method for utilizing radio resource in a wireless network according to the present disclosure.

FIG. 5 is a block diagram illustrating a terminal device according to the present disclosure.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term “processor” refers to one or more devices, circuits, and/or processing cores configured to process data, such as computer program instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Also, use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Unless otherwise defined, all terms (including technical and scientific terms) used herein have the same meaning as commonly understood. It will be further understood that terms used herein should be interpreted as having a meaning that is consistent with their meaning in the context of this specification and the relevant art and will not be interpreted in an idealized or overly formal sense unless expressly so defined herein.

As used herein, the term “terminal device” may be referred to as, for example, device, access terminal, user equipment (UE), mobile station, mobile unit, subscriber station, or the like. It may refer to any end device that can access a wireless communication network and receive services therefrom. By way of example and not limitation, the terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

Throughout the disclosure, the terms “Narrowband Physical Radio Access Channel (NPRACH)” and “Physical Radio Access Channel (PRACH)” are exchangeable in use.

In an Internet of things (IoT) scenario, a terminal device may represent a machine or other device that performs monitoring and/or measurements, and transmits the results of such monitoring and/or measurements to another terminal device and/or a network equipment. In this case, the terminal device may be a machine-to-machine (M2M) device, which may, in a 3rd generation partnership project (3GPP) context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

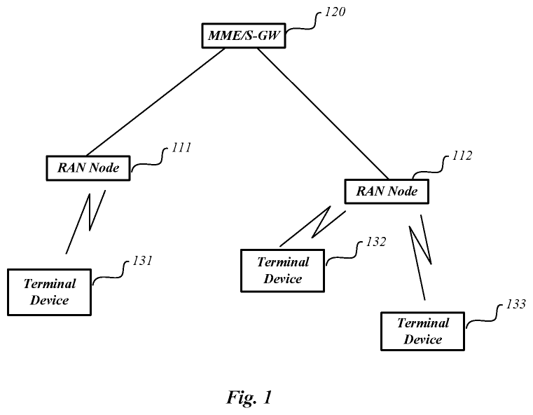

FIG. 1 shows a typical architecture for NB-IoT. As shown in FIG. 1, radio access network (RAN) nodes 111 and 112, e.g., eNodeB or gNodeB are in communication with a core network (CN) function node 120, e.g., MME/S-GW, and terminal devices 131-133, e.g., UEs may access to RAN via the RAN node 111 or 112.

In the present disclosure, allocation information is configured to allocate PRACH resources for non-anchor carriers to an enhanced coverage level. In particular, each of PRACH resources for non-anchor carriers has a respective selection probability. That is, a respective selection probability is assigned to each of PRACH resources for non-anchor carriers. Thus, the terminal device can make a PRACH resources selection on the basis of the respective selection probability. The selection probability can be determined based on at least one of the following aspects: performance in previous sessions on the non-anchor carriers, PRACH success rate, type of service, load, quality of service (QoS) and nrs-PowerOffsetNonAnchor. Alternatively, the selection probability can be customized by a user, e.g., an operator.

Moreover, in the present disclosure, the radio resource configuring for a terminal device, e.g., assigning the selection probabilities to the non-anchor carriers NPRACH resources, can be performed only on some enhanced coverage levels. For example, the configuring may be only made for CE levels 1 and 2 without CE level 0. In an illustrative example, the non-anchor carrier for specific NPRACH resource may be configured for one of CE levels 1 and 2 or the combination thereof, i.e.:
CE level 1;
CE level 2; or
CE level 1 and CE level 2.

Preferably, in the present disclosure, for each enhanced coverage level, one anchor carrier NPRACH resource is still be allocated, or NPRACH resource partitioning is still maintained for anchor carrier, so as to provide backward compatibility for NB-IoT UEs without capability for random access on non-anchor carriers.

In the present disclosure, by means of a mapping relationship between paging carriers and the non-anchor carriers specified in paging configuring information received from RAN node, a terminal device can determine a paging carrier to be listened (also referred to as “listened paging carrier” hereinafter) by selecting from the candidate paging carriers one corresponding to the non-anchor carrier via which the terminal device carries out the physical random access.

In an illustrative example, non-anchor UL NPRACH carriers for one specific enhanced coverage level may be indexed with downlink (DL) paging carriers. Thus, upon selecting the non-anchor carrier, the listened paging carrier is determined.

In the present disclosure, the allocation information and the paging configuration information may be included in a system information block sent from a RAN node to a terminal device. Preferably, the system information block is in form of SystemInformationBlockType22-NB with some modifications. For illustrative purpose, a modified version of the SystemInformationBlockType22-NB, in which new information elements (IEs) for describing the allocation information and the paging configuration information are included, is shown as follows:

SystemInformationBlockType22-NB information element

-- ASN1START
SystemInformationBlockType22-NB-r14 : : = SEQUENCE {

| | |
|---|---|
| dl-ConfigList-r14 | DL-ConfigCommonList-NB-r14 OPTIONAL, -- |

Need OR

| | |
|---|---|
| ul-ConfigList-r14 | UL-ConfigCommonList-NB-r14 OPTIONAL, -- |

Need OR

| | | |
|---|---|---|
| pagingWeightAnchor-r14 | PagingWeight-NB-r14 | OPTIONAL, -- |

```
Cond pcch-config
    nprach-ProbabilityAnchorList-r14 NPRACH-ProbabilityAnchorList-NB-r14
    OPTIONAL, -- Cond nprach-config
```

| | | |
|---|---|---|
| lateNonCriticalExtension | OCTET STRING | OPTIONAL, |

...,

| | |
|---|---|
| [[ mixedOperationModeConfig-r15 | SEQUENCE { |

| | |
|---|---|
| dl-ConfigListMixed-r15 | DL-ConfigCommonList-NB-r14 OPTIONAL, |

-- Cond dl-ConfigList

| | |
|---|---|
| ul-ConfigListMixed-r15 | UL-ConfigCommonList-NB-r14 OPTIONAL, |

-- Cond ul-ConfigList

| | | |
|---|---|---|
| pagingDistribution-r15 | ENUMERATED {true} | OPTIONAL, |

-- Need OR

| | | |
|---|---|---|
| nprach-Distribution-r15 | ENUMERATED {true} | OPTIONAL |

-- Need OR

| | |
|---|---|
| } | OPTIONAL, -- Need |

OR

| | |
|---|---|
| ul-ConfigList-r15 | UL-ConfigCommonListTDD-NB-r15 OPTIONAL |

```
    -- Cond TDD
    ]],
    [[
```

| | |
|---|---|
| ul-ConfigList-r17 | UL-ConfigFlexibleList-NB-r17 OPTIONAL -- |

Cond Flexible
]]
}

| | |
|---|---|
| DL-ConfigCommonList-NB-r14 : : = | SEQUENCE (SIZE (1.. |

maxNonAnchorCarriers-NB-r14) ) OF

| | |
|---|---|
| | DL-ConfigCommon-NB-r14 |
| UL-ConfigCommonList-NB-r14 : : = | SEQUENCE (SIZE (1.. |

maxNonAnchorCarriers-NB-r14) ) OF

| | |
|---|---|
| | UL-ConfigCommon-NB-r14 |
| UL-ConfigCommonListTDD-NB-r15 : : = | SEQUENCE (SIZE (1.. |

maxNonAnchorCarriers-NB-r14) ) OF

| | |
|---|---|
| | UL-ConfigCommonTDD-NB-r15 |
| UL-ConfigFexibleList-NB-r17 : : = | SEQUENCE (SIZE (1.. |

maxNonAnchorCarriers-NB-r14) ) OF

UL-ConfigFlexible-NB-r17

| | |
|---|---|
| DL-ConfigCommon-NB-r14 : : = | SEQUENCE { |

| | |
|---|---|
| dl-CarrierConfig-r14 | DL-CarrierConfigCommon-NB-r14, |

| | | |
|---|---|---|
| pcch-Config-r14 | PCCH-Config-NB-r14 | OPTIONAL, -- Need |

OR
...,

| | |
|---|---|
| [[ wus-Config-r15 | WUS-ConfigPerCarrier-NB-r15 |

```
    OPTIONAL -- Cond WUS
    ]],
```

| | |
|---|---|
| [[ gwus-Config-r16 | WUS-ConfigPerCarrier-NB-r15 |

```
    OPTIONAL -- Cond GWUS
    ]]
}
```

| | |
|---|---|
| PCCH-Config-NB-r14 : : = | SEQUENCE { |

| | |
|---|---|
| npdcch-NumRepetitionPaging-r14 | ENUMERATED { |

r1, r2, r4, r8, r16, r32, r64, r128,
r256, r512, r1024, r2048,
spare4, spare3, spare2, spare1} OPTIONAL,

-- Need OP

| | |
|---|---|
| pagingWeight-r14 | PagingWeight-NB-r-14 DEFAULT w1, |

...
}

| | |
|---|---|
| PagingWeight-NB-r14 : : = | ENUMERATED {w1, w2, w3, w4, w5, w6, w7, w8, |

w9, w10, w11, w12, w13, w14, w15, w16}

| | |
|---|---|
| UL-ConfigCommon-NB-r14 : : = | SEQUENCE { |

| | |
|---|---|
| ul-CarrierFreq-r14 | CarrierFreq-NB-r13, |
| nprach-ParametersList-r14 | NPRACH-ParametersList-NB-r14 OPTIONAL, |

-- Need OR
...,

| | |
|---|---|
| [[ nprach-ParametersListEDT-r15 | NPRACH-ParametersList-NB-r14 OPTIONAL -- |

Cond EDT
]]
}

| | |
|---|---|
| UL-ConfigCommonTDD-NB-r15 : : = | SEQUENCE { |

| | |
|---|---|
| tdd-UL-DL-AlignmentOffset-r15 | TDD-UL-DL-AlignmentOffset-NB-r15, |
| nprach-ParametersListTDD-r15 | NPRACH-ParametersListTDD-NB-r15 |

```
    OPTIONAL, -- Need OR
    ...
}
```

| | |
|---|---|
| UL-ConfigFlexible-NB-r17 : : = | SEQUENCE { |
| ul-CarrierFreq-r17 | CarrierFreq-NB-r13, |
| nprach-ParametersList-r17 | NPRACH-ConfigNonAnchorList-r17 |

OPTIONAL, -- Need OR

| | |
|---|---|
| nprach-ParametersListEDT-r17 | NPRACH-ConfigNonAnchorList-r17 |

```
    OPTIONAL, -- Cond EDT
    ...
}
NPRACH-configNonAnchorList-r17 : : = SEQUENCE (SIZE (1..
maxNPRACH-Resources-UB-r13)) OF
```

| | |
|---|---|
| | NPRACH-configNonAnchor-r17 |
| NPRACH-configNonAnchor-r17 : : = | SEQUENCE { |
| nprach-probabilityNonAnchor-r17 | NPRACH-ProbabilityAnchor-NB-r14 |

OPTIONAL, -- Need OR

| | | |
|---|---|---|
| nprach-Parameters-r14 | UPRACH-Parameters-NB-r14 | OPTIONAL, -- Need |

OR

| | | |
|---|---|---|
| nprach-CELevel-r17 | NPRACH-CELevel-r17 | OPTIONAL, -- Need |

OR

| | |
|---|---|
| pagingCarrierIndex-r17 | INTEGER (1..maxNonAnchdorCarriers-uB-r14) |

```
    OPTIONAL, -- Need OR
    ...
}
```

| | |
|---|---|
| NPRACH-CBLevel-r17 : : = | SEQUENCE { |

| | |
|---|---|
| nprach-CELevel-r17 | ENUMERATED (ce0, ce1, ce2) |

OPTIONAL
}
NPRACH-ProbabilityAnchorList-NB-r14 : : = SEQUENCE (SIZE (1..
maxNPRACH-Resources-NB-r13) ) OF

| | |
|---|---|
| | NPRACH-ProbabilityAnchor-NB-r14 |
| NPRACH-ProbabilityAnchor-NB-r14 : : = | SEQUENCE { |
| nprach-ProbabilityAnchor-r14 | ENUMERATED { |
| | zero, oneSixteenth, oneFifteenth, |

oneFourteenth,

oneThirteenth, oneTwelfth,

oneEleventh, oneTenth,

oneNinth, oneEighth, oneSeventh,

oneSixth,

| | |
|---|---|
| | oneFifth, oneFourth, oneThird, |
| oneHalf} | |

OPTIONAL -- Need OP

}
-- ASN1STOP

| Conditional presence | Explanation |
|---|---|
| flexible | This field is optionally present, Need OR, if the |
| | field ul-ConfigList-r14 is absent. Otherwise the |
| | field is not present. |

When network or RAN assigns NPRACH resources for a legacy UE, it may configure one of the following aspects:
a) If random Access only uses anchor carrier, the above condition flexible is applicable.
b) If there are multiple non-anchor carriers, the non-anchor NPRACH resources may be split into two parts, e.g., one for supporting legacy NPRACH resource assignment and the other for supporting Rel-17 flexible assignment. Rel-17 UE shall always follow the flexible assignment if available. In such cases, the above condition “flexible” is not required.

For the enum “nprach-CELevel-r17 ENUMERATED {ce0, ce1, ce2} OPTIONAL”, it can be depicted with RSRP threshold range as below:
initialNRSRP-Level-r16 INTEGER (0 . . . 2)
initialNRSRP-Level: Indicates the NRSRP level of the NPRACH resource selected for the first preamble transmission.

Basically, derived from rsrp-ThresholdsPrachInfoList as provided in 3GPP TS 36.331.

rsrp-ThresholdsPrachInfoList

The criterion for UEs to select a NPRACH resource. Up to 2 RSRP threshold values can be signaled. The first element corresponds to RSRP threshold 1, the second element corresponds to RSRP threshold 2. See 3GPP TS 36.321. If absent, there is only one NPRACH resource.

A UE that supports powerClassNB-14 dBm-r14 shall correct the RSRP threshold values before applying them as follows:

RSRP threshold=Signaled RSRP threshold−min{0,(14-min(23,P-Max))}
where P-Max is the value of p-Max field in System Information BlockType1-NB.

In the present disclosure, the uplink (UL) carrier configured for random access for a certain CE Level can also be configured for paging by network or RAN. The network may use the same CE level as NPRACH or could use different assignment for CE level for paging or only configure the UL carrier for the purpose of paging and omit the NPRACH flexible carrier selection as described above.

For pagingCarrierIndex, one non-anchor UL NPRACH carrier for one specific enhanced coverage level is associated with a DL paging carrier. If absent, it indicates that there is no associated DL paging carrier. The indices of the carriers in the list are arranged as follows: the first entry in the list is indexed with ‘1’, the second entry is indexed with ‘2’ and so on.

The following embodiments will be described in connection with the architecture as shown in FIG. 1. However, it can be understood that, although the embodiments herein are described in the context of the NB IoT system, the embodiments can be also applied to other different telecommunication systems. It will be also understood that, although specific terms are used in the embodiments, the embodiments are not limited to those specific terms but may be applied to all similar entities. For example, the term “RAN node” herein may refer to e.g. access point, base station, macro base station, femto base stations, NodeB (NB), eNodeB (eNB), gNodeB (gNB) and so on.

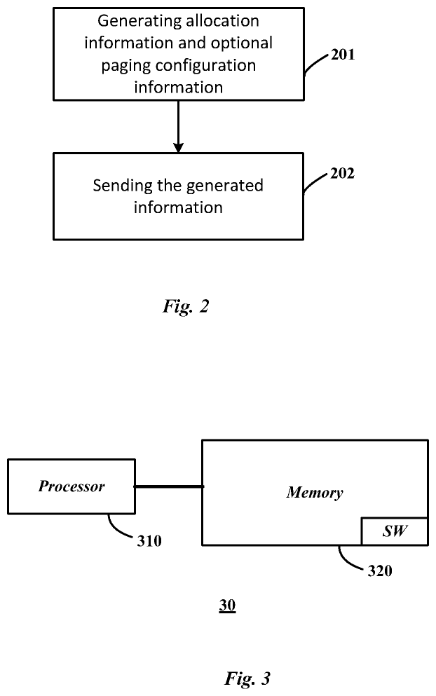

FIG. 2 schematically illustrates a flowchart of a method for configuring radio resource for a terminal device in a NB-IoT according to the present disclosure.

The flowchart as shown in FIG. 2 comprises the following steps performed by a RAN node, e.g., base station, eNB and gNB.

Step 201: The RAN node generates allocation information configured to allocate PRACH resources for non-anchor carriers to an enhanced coverage level, e.g., CE level 1 or CE level 2. In the allocation information, a respective selection probability is assigned to each of the PRACH resources for non-anchor carriers. Thus, the terminal device can make a PRACH resources selection for physical random access on the basis of the respective selection probability.

In an illustrative example, the RAN node further generates paging configuration information configured to specify a mapping relationship between paging carriers and the non-anchor carriers. Thus, the terminal device can select a listened paging carrier from the paging carriers on the basis of the mapping relationship. In particular, the listened paging carrier may be corresponding to the non-anchor carrier via which the terminal device carries out the physical random access.

In another illustrative example, besides the PRACH resources for non-anchor carriers, the allocation information is further configured to allocate a PRACH resource for an anchor carrier to the enhanced coverage level.

In another illustrative example, the allocation information is only applied to some of the enhanced coverage levels. For example, the enhanced coverage levels may be one of the CE levels 0-2, and the allocating of the PRACH resources for non-anchor carriers is only directed toward some of the CE levels, e.g., CE level 1; CE level 2; or CE levels 1 and 2.

In another illustrative example, the respective selection probability may be customized by a user or determined based on at least one of the following aspects: performance in previous sessions on the non-anchor carriers, PRACH success rate, type of service, load, quality of service (QoS) and nrs-PowerOffsetNonAnchor.

Step 202: The RAN node sends the allocation information to the terminal device. In case where the paging configuration information is generated, the RAN node also sends the paging configuration information to the terminal device.

In another illustrative example, the allocation information and the paging configuration information are included in a system information block, e.g., SystemInformationBlockType22-NB as described above.

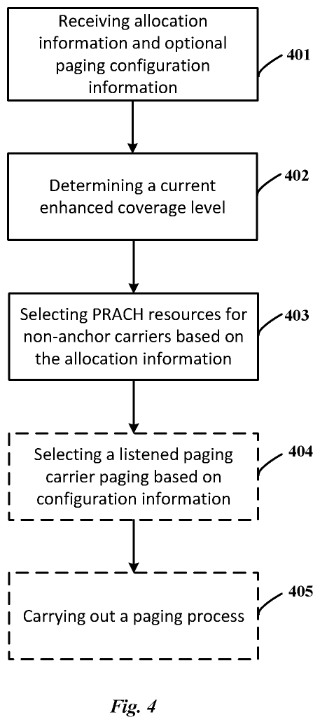

FIG. 3 is a block diagram illustrating an apparatus for configuring radio resource for a terminal device in a wireless network according to the present disclosure.

With reference to FIG. 3, an apparatus 30 comprises a processor 310 and memory 320 in communication with the processor 310. The memory 320 is configured to store instruction codes SW which are executable, when executed by the processor 310, to cause the apparatus 30 to perform some or all of the method steps as shown in FIG. 2. In this embodiment, the apparatus 30 may be a base station, an eNodeB or gNodeB.

FIG. 4 schematically illustrates a flowchart of a method for utilizing radio resource in a wireless network according to the present disclosure.

The flowchart as shown in FIG. 4 comprises the following steps performed by a terminal device.

Step 401: The terminal device receives from a RAN node allocation information configured to allocate PRACH resources for non-anchor carriers to an enhanced coverage level, e.g., CE level 1 or CE level 2. In the allocation information, a respective selection probability is assigned to each of the PRACH resources for non-anchor carriers. Preferably, besides the PRACH resources for non-anchor carriers, the allocation information is further configured to allocate a PRACH resource for an anchor carrier to the enhanced coverage level.

In an illustrative example, optionally, the terminal device further receives paging configuration information configured to specify a mapping relationship between paging carriers and the non-anchor carriers. Preferably, the allocation information and the paging configuration information may be included in a system information block, e.g., SystemInformationBlockType22-NB as described above.

Step 402: The terminal device determines a current enhanced coverage level, e.g., by performing a DL measurement.

Step 403: for the current enhanced coverage level as determined at step 402, the terminal device selects one or more resources from the PRACH resources for non-anchor carriers based on the allocation information so as to carry out the physical random access.

In case where the paging configuration information is received at step 401, the flowchart may further comprises the following steps:

Step 404: The terminal device selects a listened paging carrier from the paging carriers on the basis of the mapping relationship. In particular, the listened paging carrier may be corresponding to the non-anchor carrier via which the terminal device carries out the physical random access.

Step 405: The terminal device carries out a paging process via the listened paging carrier as selected at step 404.

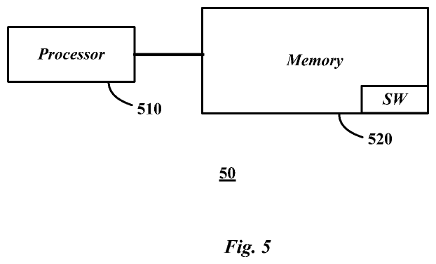

FIG. 5 is a block diagram illustrating a terminal device according to the present disclosure.

With reference to FIG. 5, an apparatus 50 comprises a processor 510 and memory 520 in communication with the processor 510. The memory 520 is configured to store instruction codes SW which are executable, when executed by the processor 510, to cause the apparatus 50 to perform some or all of the method steps as shown in FIG. 4. In this embodiment, the apparatus 50 may be one selected from a group consisting of a user equipment (UE), a mobile station, a mobile unit, a subscriber station, a portable computer, an image capture terminal device, a gaming terminal device, a music storage and playback appliance, a mobile phone, a cellular phone, a smart phone, a tablet, a wearable device and a personal digital assistant.

In one or more embodiments as described above, the following advantages will be achieved.
PRACH or NPRACH resources based on enhanced coverage levels can be more flexibly configured for NB-IoT non-anchor carriers. In particular, the non-anchor carrier(s) can be configured with one specific selection probability. Moreover, at network side or RAN side, it is able to configure PRACH or NPRACH resources for enhanced coverage levels without including CE level 0 in system information, e.g., only CE level 1 and/or CE level 2 are included. PRACH resource partitioning is simplified or even has no need for specific carriers.
It can reduce the possibility of changing an NB-IoT UE from the anchor/non-anchor carrier used during random access procedure to another anchor/non-anchor carrier for unicast transmissions.
As a PRACH or NPRACH resource is not partitioned for one non-anchor carrier, it decreases the possibility of collision between NPRACH and NPUSCH, and also decreases the possibility of NPUSCH tone reduction due to collision between NPRACH and NPUSCH.
If a certain CE level has larger proportion of RACH request than other, it provides flexibility to assign more resource/carriers dedicated to that CE level.
The peak NPRACH processing load can be reduced if different carriers are assigned to different CE levels, this is advantageous in terms of capacity.
Potential NPRACH resource overlap from neighbor cells' non-anchor carrier can be reduced, false preambles, i.e., selected by UEs that estimate wrong CE level, caused by NPRACH interference can be reduced especially for CEO (the symbol group hopping pattern difference with PCI is only among repetitions).
The carrier selected for NPRACH procedure is associated with a paging carrier to be listened and thus the paging carrier selection is simplified.

It should be noted that the aforesaid embodiments are illustrative instead of restricting, substitute embodiments may be designed by those skilled in the art without departing from the scope of the claims enclosed. The wordings such as “include”, “including”, “comprise” and “comprising” do not exclude elements or steps which are present but not listed in the description and the claims. It also shall be noted that as used herein and in the appended claims, the singular forms “a”, “an”, and “the” include plural referents unless the context clearly dictates otherwise. Embodiments can be achieved by means of hardware including several different elements or by means of a suitably programmed computer. In the unit claims that list several means, several ones among these means can be specifically embodied in the same hardware item. The use of such words as first, second, third does not represent any order, which can be simply explained as names.

1-20. (canceled)

21. A method for configuring radio resource for a terminal device in a wireless network, the method comprising:
a) generating allocation information configured to allocate physical random access channel (PRACH) resources for non-anchor carriers to an enhanced coverage level, wherein a respective selection probability, on the basis of which the terminal device makes a PRACH resources selection to carry out physical random access, is assigned to each of the PRACH resources for non-anchor carriers; and
b) sending the allocation information to the terminal device.

22. The method according to claim 21,
wherein the step a) further comprises:
generating paging configuration information configured to specify a mapping relationship between paging carriers and the non-anchor carriers, on the basis of which the terminal device selects, from the paging carriers, one corresponding to the non-anchor carrier via which the terminal device carries out the physical random access, and
the step b) further comprises:
sending the paging configuration information to the terminal device.

23. The method according to claim 21, wherein the enhanced coverage level is one of coverage enhancement (CE) levels 0, 1 and 2, and the allocating of the physical random access channel (PRACH) resources for non-anchor carriers is directed only toward some of the CE levels 0, 1 and 2.

24. The method according to claim 21, wherein the respective selection probability is customized by a user.

25. The method according to claim 21, wherein the respective selection probability is determined based on at least one of the following aspects: performance in previous sessions on the non-anchor carriers, PRACH success rate, type of service, load, quality of service (QoS) and nrs-PowerOffsetNonAnchor.

26. The method according to claim 22, wherein the allocation information and the paging configuration information are included in a system information block.

27. The method according to claim 21, wherein the wireless network is Narrowband Internet of Things (NB-IoT).

28. An apparatus for configuring radio resource for a terminal device in a wireless network, the apparatus comprising:
a memory with instructions stored in the memory; and
a processor in communication with the memory, and wherein execution of the instructions by the processor configures the processor to:
a) generate allocation information configured to allocate physical random access channel (PRACH) resources for non-anchor carriers to an enhanced coverage level, wherein a respective selection probability, on the basis of which the terminal device makes a PRACH resources selection to carry out physical random access, is assigned to each of the PRACH resources for non-anchor carriers; and
b) send the allocation information to the terminal device.

29. The apparatus according to claim 28, wherein the apparatus is a base station configured for operation in the wireless network.

30. A method for utilizing radio resource in a wireless network, the method comprising:
a) receiving allocation information configured to allocate physical random access channel (PRACH) resources for non-anchor carriers to an enhanced coverage level, wherein a respective selection probability, on the basis of which a PRACH resources selection for non-anchor carriers is made to carry out physical random access, is assigned to each of the PRACH resources for non-anchor carriers; and
b) determining a current enhanced coverage level; and
c) for the current enhanced coverage level, selecting one or more resources from the PRACH resources for non-anchor carriers based on the allocation information so as to carry out the physical random access.

31. The method according to claim 30,
wherein step a) further comprises:
receiving paging configuration information configured to specify a mapping relationship between paging carriers and the non-anchor carriers, and
the method further comprises:
d) based on the paging configuration information, selecting, from the paging carriers, one corresponding to the non-anchor carrier via which the physical random access is carried out; and
e) carrying out a paging process via the selected paging carrier.

32. The method according to claim 31, wherein the allocation information and the paging configuration information are included in a system information block.

33. The method according to claim 30, wherein the enhanced coverage level is one of coverage enhancement (CE) levels 0, 1 and 2, and the allocating of the physical random access channel (PRACH) resources for non-anchor carriers is directed only toward some of the CE levels 0, 1 and 2.

34. The method according to claim 30, wherein the respective selection probability is customized by a user.

35. The method according to claim 30, wherein the respective selection probability is determined based on at least one of the following aspects: performance in previous sessions on the non-anchor carriers, PRACH success rate, type of service, load, quality of service (QoS) and nrs-PowerOffsetNonAnchor.

36. The method according to claim 30, wherein the wireless network is Narrowband Internet of Things (NB-IoT).

37. A terminal device for use in a wireless network, the terminal device comprising:
a memory storing instructions; and
a processor in communication with the memory, and wherein execution of the instructions by the processor configures the processor to:
a) receive allocation information configured to allocate physical random access channel (PRACH) resources for non-anchor carriers to an enhanced coverage level, wherein a respective selection probability, on the basis of which a PRACH resources selection for non-anchor carriers is made to carry out physical random access, is assigned to each of the PRACH resources for non-anchor carriers; and
b) determine a current enhanced coverage level; and
c) for the current enhanced coverage level, select one or more resources from the PRACH resources for non-anchor carriers based on the allocation information so as to carry out the physical random access.
